(19) United States
(12) Patent Application Publication
(10) Pub. No.: US 2003/0085989 A1
(43) Pub. Date: May 8, 2003

(54) Mobile communication device with instant image capture and transmission

(76) Inventor: Hiok-Nam Tay, Irvine, CA (US)

Correspondence Address: Hiok - Nam Tay, 6 Mount Vernon, Irvine, CA, 92620, US

(21) Appl. No.: 10/289,019

(22) Filed: Nov. 6, 2002

Related U.S. Application Data
(60) Provisional application No. 60/348,485, filed on Nov. 7, 2001.

(51) Int. Cl. H04N 7/14

(52) U.S. Cl. 348/14.02

(57) ABSTRACT

A mobile communication device (100) having image capture function and provided with a button to activate image capture and transmission. The button may be a specially provided button (80). Alternatively, the button may be one of the alphanumeric buttons (60) configured to activate image capture and transmission, the configuration being through pressing a specially provided button (80). An alternative mobile communication device (200) having image capture function activates image capture and transmission by pressing two buttons in succession.

### CROSS REFERENCE TO RELATED APPLICATIONS

This application claims priority under 35 U.S.C 119(e) to Provisional Patent Application Ser. No. 60/348,485 filed on Nov. 7, 2001.

### BACKGROUND

1. Field of Invention

This invention relates to mobile communication devices, specifically to wireless cellular telephone devices that incorporate digital imaging capability.

### BACKGROUND

2. Description of Prior Art

In the field of mobile telephone communications, digital imaging function is newly being incorporated as a means to provide video communication or to capture still images for attachment to emails transmitted over mobile telephone system. However, the image capture step and the image transmission step are two separate steps requiring numerous key presses and therefore time consuming. For example, the transmission step itself may require the user to key in the telephone number of the recipient, or to select the recipient from a list displayed in the display unit of the mobile telephone unit.

It is important under certain circumstances to capture and transmit the still images or video to the recipient very quickly. For example, a valuable service that may be provided by the mobile phone service provider is to provide a internet site where images or videos captured are transmitted to and stored for later retrieval. Together with such service, a instant image capture and transmit function on the mobile phone can become an effective crime deterrent in that pictures of potential attackers are instantly transmitted to a personal secure remote site accessible by police authorities should the holder of the mobile telephone unit disappear due to acts of the attackers. Prospect of immediate identification of the attackers after police retrieval of such images discourages any further criminal activities after the potential criminals' images are captured and transmitted to the remote site.

Another circumstance is where the mobile telephone unit comes with limited storage and relies on transmission to remote site for storage. For quick shot-to-shot picture taking, there is minimal time to set up the transmission choices by selection through menu. A mobile telephone unit equipped with instant image capture-and-transmission capability, on the other hand, allows the user to lose minimal time from shot to shot as long as the mobile telephone unit is pre-configured to transmit images to a pre-designated destination, which may be the mobile telephone service provider. The images and/or video thus capture can then be retrieved later via internet, for example, from said destination.

### SUMMARY OF INVENTION

This invention describes a mobile telephone unit incorporating a digital imaging unit for image and/or video capture and a means for combining in one both image capture and image transmission activation steps by providing in one embodiment a special snap button pre-configured to capture images and transmit to a pre-configured recipient, and possibly combining other information transmittal such as date and time, location information, instant recorded voice message, and/or other text/control messages along with the transmission. Different press sequences selects among different sets of recipient and additional information transmittal.

In a second preferred embodiment, a special button is provided to activate the mobile phone device into imaging mode wherein each alphanumeric button and/or other ordinary buttons on the mobile telephone unit assumes special pre-configured image capture/transmission function. For example, in this second preferred embodiment, pressing the special button followed by alphanumeric button “1” may be pre-configured to transmit a single still image to a first pre-designated recipient, together with a first set of information transmittal, whereas pressing the special button followed by alphanumeric button “2” may be pre-configured to transmit a single still image to a second pre-designated recipient, together with a second set of information transmittal.

In a third preferred embodiment, no special button is provided for image capture/transmission. Rather, certain pre-designated press-sequences on individual ordinary buttons or across buttons within pre-designated pairs of buttons activate pre-designated functions to capture and transmit still-image/video to pre-designated recipients. Each such button or pair of buttons is associated with a specific video capture function, recipient, and a pre-configured set of information transmittals.

### BRIEF DESCRIPTIONS OF THE DRAWINGS

FIG. 1 is a diagram illustrating a mobile communication device configured according to the first and second preferred embodiment of this invention.

FIG. 2 is a diagram illustrating a mobile communication device configured according to the third preferred embodiment of this invention.

### DETAIL DESCRIPTION OF PREFERRED EMBODIMENTS

With reference to the Figures, exemplary embodiments of the invention will now be described. The exemplary embodiments are described primarily with reference to block diagrams. It should be appreciated that not all components necessary for a completed implementation of a practical system are illustrated or described in detail. Rather, only those components necessary for a thorough understanding of the invention are illustrated and described. Furthermore, components which are either conventional or may be readily designed and fabricated in accordance with the teachings provided herein are not described in detail.

### First Preferred Embodiment

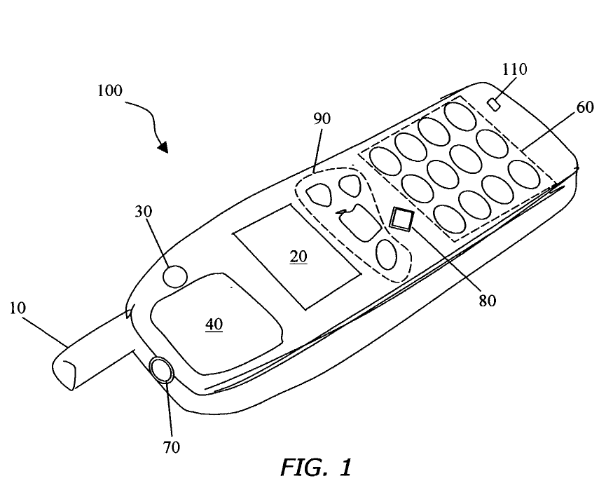

FIG. 1 illustrates a mobile communication device according the first preferred embodiment of the invention. This mobile communication device is formed of an antenna 10, an earpiece 40, a display unit 20, a power on/off button 30, a group of alphanumeric buttons 60, a group of on-display menu navigation buttons 90, a microphone 110, a digital imaging unit 70 for still image or motion video capture, and a snap button 80.

Mobile communication device 100 is provided with a digital imaging unit 70 and a snap button 80. Alphanumeric buttons 60 are used for normal hand dialing or menu entry purposes. On-display menu navigation buttons 90 are used for controlling the functions of user menus displayed in display unit 20. Antenna 10 transmits and receives wireless signals from and to mobile communication device 100 enabling remote communication with wireless base-stations. On/Off button 30 alternates between powering on or off mobile communication device 100 each time it is toggled.

Digital imaging unit 70 is capable of capturing continuous motion video or still image into digital format. Snap button 80 controls the imaging function of digital imaging unit 70 and the transmission function of mobile communication device 100.

In this first embodiment, pressing snap button 80 in different ways causes mobile communication device 100 to capture and transmit single still images or continuous motion video. Single press of snap button 80 causes mobile communication device 100 to capture a single still image and transmits this image to a first pre-designated recipient. Along with the image, mobile communication device 100 may also transmit various information such as a pre-configure text message, date and time, location information if mobile communication device 100 further comprises a global position satellite (GPS) unit or any other location determining device, and/or an instantly recorded brief voice message recorded by microphone 110 of mobile communication device 100 at the time of such transmission.

In this embodiment, continuously holding down snap button 80 causes mobile communication device 100 to capture continuous motion video and transmits this video to a second pre-designated recipient. Along with the video, mobile communication device 100 may also transmit various information such as a pre-configure text message, date and time, location information if mobile communication device 100 further comprises a global position satellite (GPS) unit or any other location determining device, and/or an instantly recorded brief voice message recorded by microphone 110 of mobile communication device 100 at the time of such transmission.

In this embodiment, a quick sequence of double press of button 80 causes mobile communication device 100 to capture a single still image and transmits this image to a third pre-designated recipient. Along with the image, mobile communication device 100 may also transmit various information such as a pre-configure text message, location information if mobile communication device 100 further comprises a global position satellite (GPS) unit or any other location determining device, and/or an instantly recorded brief voice message recorded by microphone 110 of mobile communication device 100 at the time of such transmission.

During any of the above three operations, mobile communication device 100 may also transmit special control message sequence to the recipient to activate pre-designated events such as activating emergency services to locate mobile communication device 100. Another pre-designated service will have a personnel at the recipient site speak back through earpiece 40 to provide emergency information or commands or warning and/or to continue visually monitor the situation at by sending back a control message to mobile communication device 100 to continuously transmit video.

Any sequence of presses on button 80 may be designated with a specific set of recipient, video/still-image function, voice recording, contro/text messaging and is not limited to the three operations described above.

### Second Preferred Embodiment

With reference to FIG. 1, in the second preferred embodiment, button 80 functions as a photo-mode enable button such as when pressed once or pressed and released or pressed with any other sequence, the other buttons such as alphanumeric buttons 60 or menu navigation buttons 90 assume special functions for a certain pre-determined duration of time or until button 80 is pressed again to de-activate such functions. During such time when buttons other than button 80 assume special photo-mode functions, pressing one of these buttons causes mobile communication device 100 to capture video/still-image and transmit the same to pre-designated recipients. Such video/still-image transmission may also be accompanied by location information, date and time, instant recorded voice, pre-designated text message, and/or pre-designated control message sequence similar to what is described in regards to the First Preferred Embodiment.

### Third Preferred Embodiment

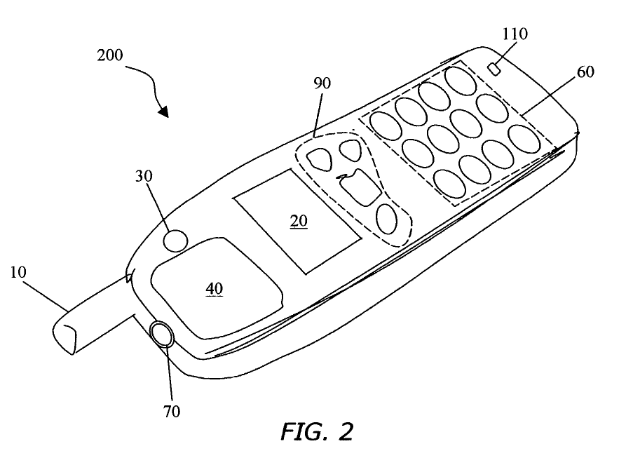

FIG. 2 illustrates a mobile communication device according the Third Preferred Embodiment of this invention. This mobile communication device is formed of an antenna 10, an earpiece 40, a display unit 20, a power on/off button 30, a group of alphanumeric buttons 60, a group of on-display menu navigation buttons 90, a microphone 110, a digital imaging unit 70 for still image or motion video capture. No special button like button 80 in FIG. 1 is provided.

In this embodiment, no special button activates image capture and transmission by mobile communication device 100. Rather, certain pre-designated press-sequences on individual ordinary buttons or across buttons within pre-designated pairs of buttons activate pre-designated functions to capture and transmit still-image/video to pre-designated recipients.

I claim:

1. A mobile communication device comprising:
a digital imaging unit;
an antenna; and,
a button to activate image capture and image data transmission via said antenna.

2. The mobile communication device of claim 1, wherein the destination of image data transmission is pre-configured.

3. The mobile communication device of claim 2, wherein location data are transmitted along with the image data.

4. The mobile communication device of claim 2, wherein time and date data are transmitted along with the image data.

5. A mobile communication device comprising:
a digital imaging unit;
an antenna;
an alphanumeric button; and
a button that configures said alphanumeric button to activate image capture and image data transmission via said antenna.

6. The mobile communication device of claim 5, wherein the destination of transmission is pre-configured.

7. The mobile communication device of claim 6, wherein location data are transmitted along with the image data.

8. The mobile communication device of claim 6, wherein time and date data are transmitted along with the image data.

9. A mobile communication device comprising:
a digital imaging unit;
an antenna; and
a pair of buttons that together activate image capture and image data transmission via said antenna.

10. The mobile communication device of claim 8, wherein the destination of transmission is pre-configured.

11. The mobile communication device of claim 10, wherein location data are transmitted along with the image data.

12. The mobile communication device of claim 10, wherein time and date data are transmitted along with the image data.
